(19) United States
(12) Patent Application Publication
(10) Pub. No.: US 2010/0067008 A1
(43) Pub. Date: Mar. 18, 2010

(54) METHOD AND APPARATUS FOR EVALUATING SAMPLES

(76) Inventor: Tudor Arvinte, Riehen (CH)

Correspondence Address: BIRCH STEWART KOLASCH & BIRCH, PO BOX 747, FALLS CHURCH, VA, 22040-0747, US

(21) Appl. No.: 12/513,293

(22) PCT Filed: Nov. 3, 2006
(86) PCT No.: PCT/EP06/10561

§ 371 Date: May 1, 2009

(51) Int. Cl. G01N 21/00; G01J 4/00

(52) U.S. Cl. 356/364; 356/432

(57) ABSTRACT

For detecting and storing information on optical properties analytical samples are digitally scanned with filters put in front of and behind the samples. A device for performing this method has means for putting filters on each side of the analytical samples. The filters may be polarizers, fluorescence filters etc.

The invention relates to a method of detecting and storing information on optical properties of analytical samples by means of a digital scanning device and to an accessory device to a flat bed scanner for performing this method.

Evaluation of analytical samples by means of a flat bed scanner or other electro-optical device is known. In WO 89/07255 extracting of information on chemical or biological assays or procedures, in particular the analysis of blood samples etc. by means of a flat bed scanner is disclosed. In US 2002/0168784 a diagnostic system using a flat bed scanner, especially determining and storing the result of agglutination assays is disclosed. The optical properties which are detected are fluorescence, colour, light scattering or characteristics of samples and resulting agglutinates.

For all these known methods the sample cuvettes, preferably in the form of micro titer plates are simply placed on the scanner bed.

It has now been found that other kinds of assays may be performed by using an accessory device in addition to the flat bed scanner.

Accordingly the invention is directed to performing the steps of putting filters on each side, i.e. in the direction of light in front of and behind the analytical samples and scanning the arrangement of samples between filters. Further the invention is directed to a device for supplementing a digital scanner by means for putting filters on each side of the analytical samples. According to a more specific embodiment of the invention the filters are polarization filters and the property detected and stored by scanning is the optical activity of the sample.

In the following a preferred embodiment of the invention is described by reference to the accompanying drawings. It is shown in

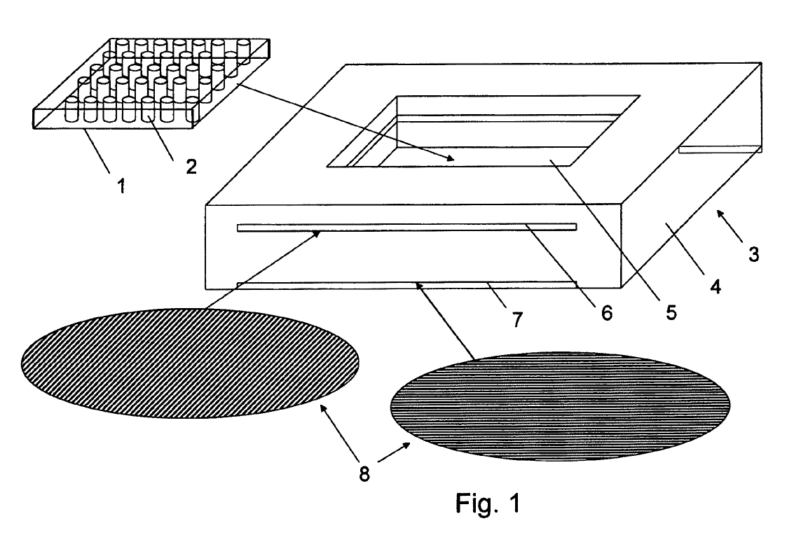

FIG. 1 a schematic perspective view of an accessory device to a flat bed scanner

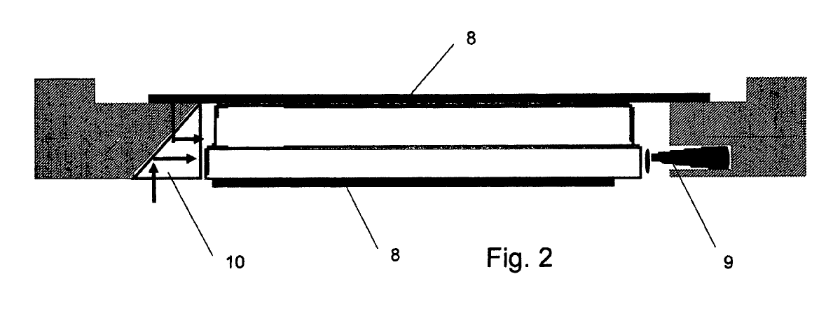

FIG. 2 a schematic cross-sectional view of the device shown in FIG. 1

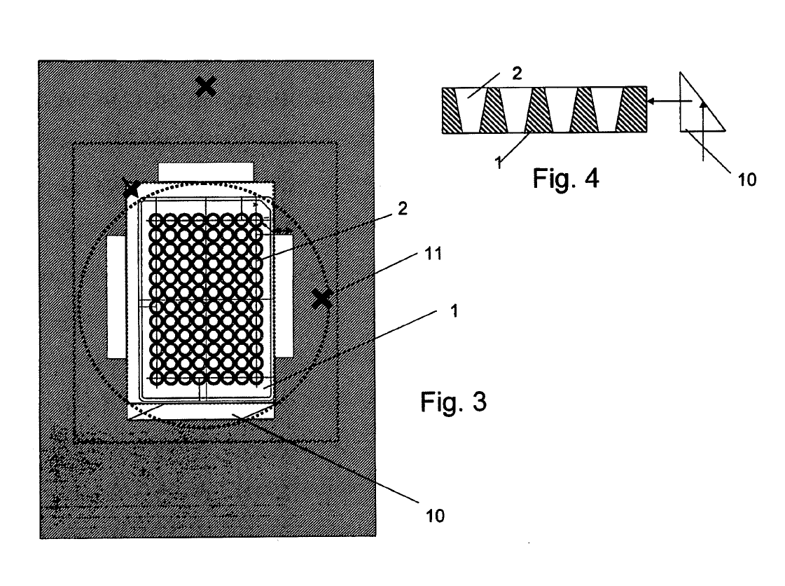

FIG. 3 a top view of the device shown in FIG. 1

FIG. 4 a detail showing the function of a prism

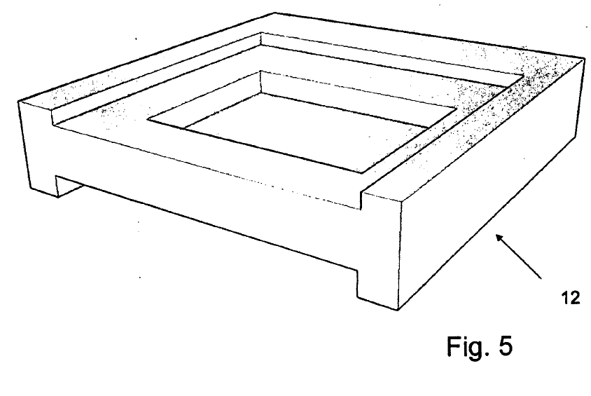

FIG. 5 an alternative version of an accessory device

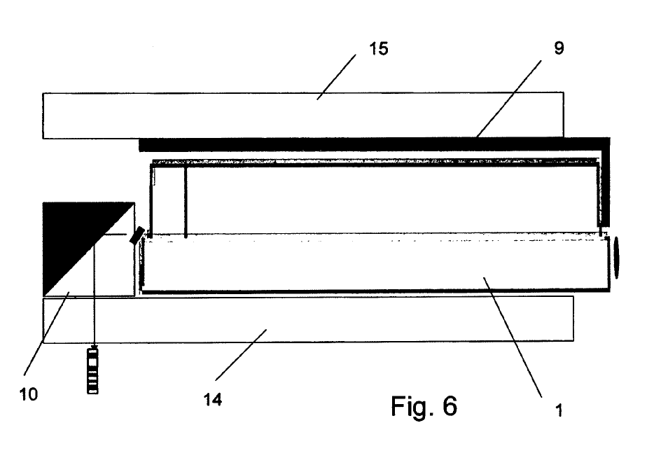

FIG. 6 sample identification by bar code

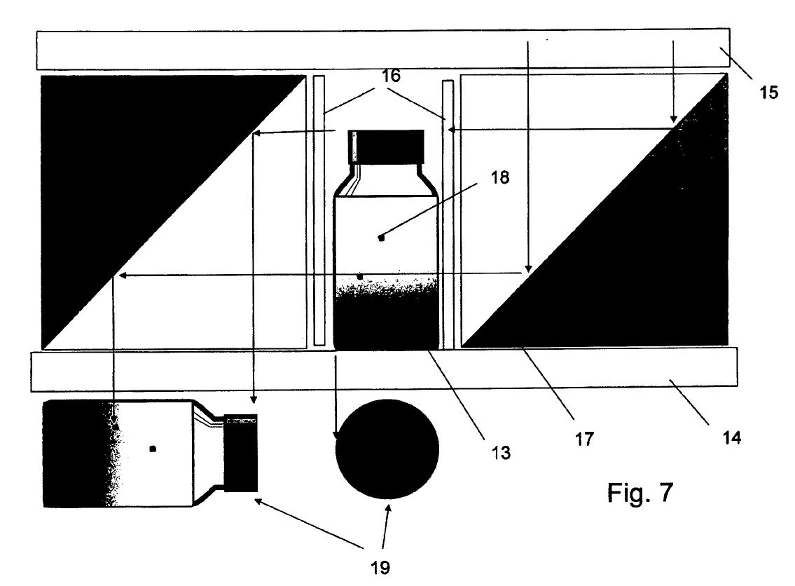

FIG. 7 an embodiment for analyzing larger objects

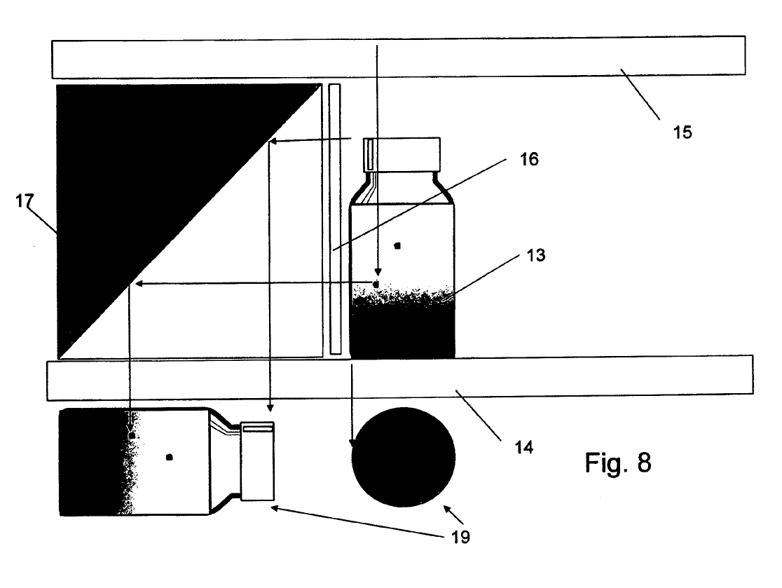

FIG. 8 another possibility of analyzing a larger object

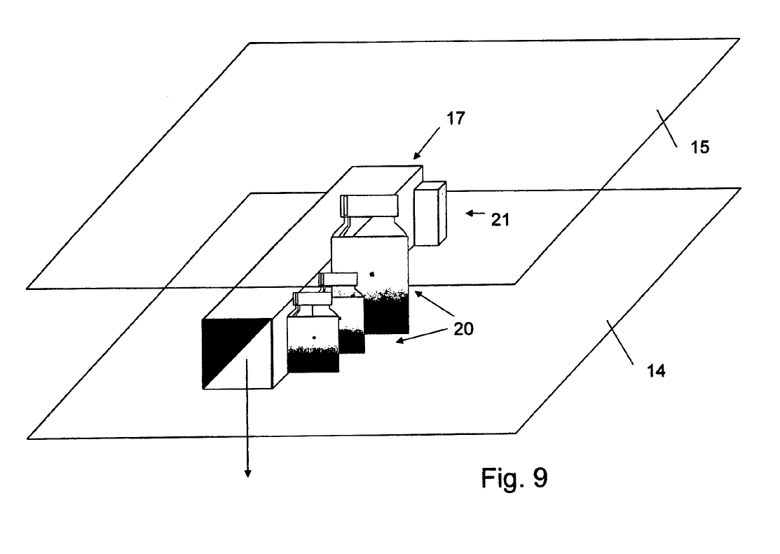

FIG. 9 simultaneous analyzing a multitude of larger objects

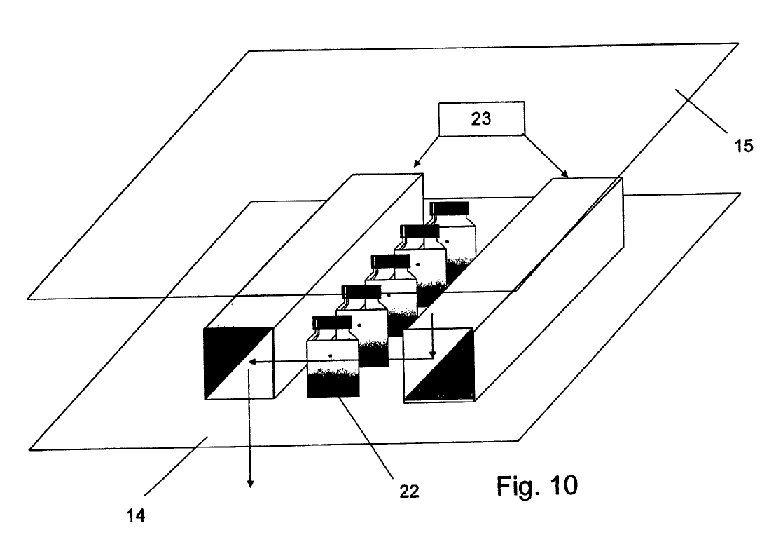

FIG. 10 analysis of an array of larger containers

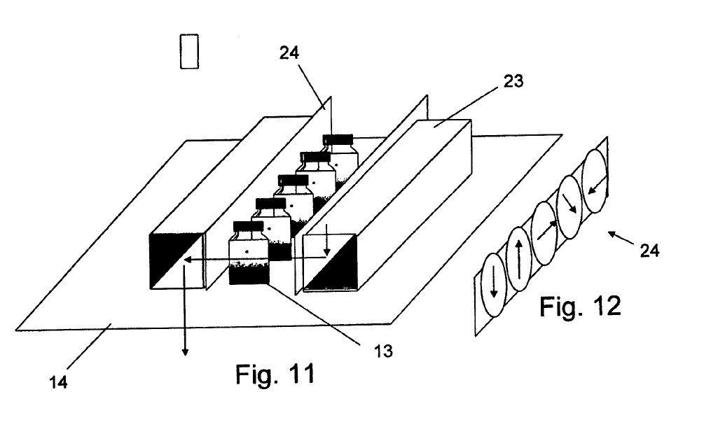

FIG. 11 an alternative possibility of analysing an array of larger containers

FIG. 12 a detail of individual filters

As shown in FIG. 1-3 a micro titer plate 1 containing a plurality of sample wells 2 is put into an encasing 3 made of fully transparent material, such as acrylic glass etc. The encasing consists of a frame 4 with an opening 5 in which the micro titer plate is placed.

Frame 4 has a first slot 6 arranged in a plane above the upper extension of an inserted micro titer plate and a second slot 7 arranged in a plane below the lower surface of the micro titer plate. The two slots are for the purpose of receiving filters 8 in the shape of thin sheets or the like.

In the present embodiment the filters 8 are polarisation filters or polarizers. For the determination presence or absence of optical activity in the individual samples of the array the polarizers have to be arranged in different relative positions, i.e. parallel, crossed or intermediate. In FIG. 1 the polarizers are shown to be crossed. But they could also be inserted with parallel polarization directions or under any desired angle.

As shown in the cross section of FIG. 2 a positioning pin 9 may be arranged aside the micro titer plate in order to ensure defined positions of the wells.

As can also be seen in FIG. 2 and in more detail in FIG. 4, a prism 10 made of transparent material such as acrylic glass is positioned along one short side of the micro titer plate to direct the light from the side through the samples for e.g. effecting fluorescence of the samples. Several prisms may be arranged along other or all sides of the micro titer plate. As shown in FIG. 6 the prism is also used to read a bar code located at the side face of the micro titer plate for its identification. The bar code is processed automatically during image analysis.

As is well-known in the art fluorescence radiation may be measured between crossed polarizers or through appropriate fluorescence and/or colour filters. To that effect one or both polarizers are replaced or supplemented by other types of filters.

As shown in the top view of FIG. 3 markers 11 in the form of a sticker or a scratch are provided on the filters for the purpose of defining their position for image analysis.

As shown in FIG. 5, the encasing 12 of another embodiment of the invention has recessed upper and lower surfaces instead of the slots to receive the filters.

For performing the scanning of the samples the encasing together with the filters and the enclosed micro titer plate is put onto the bed of the scanner. Precise positioning of the encasing on the scanner is effected by means known as such, e.g. by hook and loop patches etc. Alternatively, the encasing may be fixedly attached to a scanner which is used exclusively for this analytical purpose.

For samples which need to be heated the filter is supplemented or replaced by an electrical heating layer of the electric blanket type. The power source for this heating appliance may be placed outside the scanner. Temperature may be controlled by means of a temperature sensor or thermostat.

In addition to filters or heating plates, identification or auxiliary sheets or covers may be put on top of the micro titer plate to enable or facilitate the identification or allowing additional quantification and analysis. These sheets or covers may contain well numbers, crosses, black circles or dots, grids or entirely black background. These help to quantify and analyze a variety of characteristics, such as surface tension, turbidity or the presence of air bubbles. In general these covers help to increase the contrast.

The device allows the scanning of a variety of consumables, such as microscopy slides, pathology slides, terasaki plates, any well plates or petri dishes. Of course, certain consumables may require a suitable adapter. There is also no need for only one plate or consumable per scan. Depending on its size several consumables can be analyzed simultaneously. It is also possible to provide a larger scanner such as A3 for accommodating several SBS size micro plates.

The device is robotic arm compatible for automatic insertion and removal of plates with standard robotic arms. There is space on all sides for access which is advantageous for easy manual access as well.

According to an alternative embodiment of the invention shown in FIGS. 7-12 larger objects such as vial or bottles may also be scanned in the same way. The encasing has of course modified dimensions. As shown in FIG. 7 a bottle 13 is placed on the scanner bed 14. The scanner is of the type which uses top illumination from its lid 15. The bottle is positioned between filters 16 and prisms 17 for being scanned from different sides. The filter behind the bottle may be supplemented or replaced by a magnifying glass. The filters may be polarizers, fluorescence filters etc. Instead of the prisms mirrors may be used as well.

The scanned lateral and bottom images 19 of the bottle are schematically shown under the scanner bed.

This may be useful in the analysis of particles 18 floating in turbid solutions including their behaviour over time such as the sedimentation kinetics. If a square of prisms or mirrors is used the bottle may be scanned from all four sides.

As shown in FIG. 8 a similar analysis of a bottle may be effected with a filter 16 and a prism or mirror 17 on only one side. FIG. 9 shows a similar arrangement with a multitude of different objects such as bottles 20 of different size and a fluorescence cuvette 21 scanned simultaneously. FIG. 10 shows the scanning of an array of identical vials 22 between prisms or mirrors 23 for e.g. floating particles etc. As shown in FIG. 11 the same arrangement may be used with filters 24 such as polarizers or fluorescence filters etc. According to a further embodiment shown in FIG. 12 individually rotatable polarizers or fluorescence filters may be associated with each vial.

Subsequent image analysis may include characterization of size, morphology of structures, identification of colour and quantification of intensities, as well as cell analysis.

1. Method of detecting and storing information on optical properties of analytical samples by means of a digital scanning device comprising putting filters on each side, i.e. in the direction of light in front of and behind the analytical samples and scanning the arrangement of samples between filters.

2. Method according to claim 1, wherein the property detected and stored by scanning is polarization images of the sample.

3. Method according to claim 1, wherein the property detected and stored by scanning is the fluorescence of the sample.

4. A device for detecting and storing information on optical properties of analytical samples by means of a digital scanning device comprising means for putting filters on each side of the analytical samples.

5. A device according to claim 4 wherein the filters are polarization filters.

6. A device according to claim 4 wherein the filters are fluorescence filters.

7. A device according to claim 4 wherein the samples are contained in wells of micro titer plates.

8. A device according to claim 4 wherein the samples are contained in bottles or vials.

9. A device according to claim 4 wherein prisms or mirrors are arranged at one or more sides of the sample.

10. A device according to claim 4 wherein at least one of the filters is supplemented or replaced by a magnifying glass.
